(19) United States
(12) Patent Application Publication
(10) Pub. No.: US 2011/0237743 A1
(43) Pub. Date: Sep. 29, 2011

(54) PROCESS FOR PRODUCING CLINGFILMS

(75) Inventors: Liqun Ren, Mannheim (DE); Gabriel Skupin, Speyer (DE)

(73) Assignee: BASF SE, Ludwigshafen (DE)

(21) Appl. No.: 13/070,896

(22) Filed: Mar. 24, 2011

Related U.S. Application Data
(60) Provisional application No. 61/316,885, filed on Mar. 24, 2010.

(51) Int. Cl. C08L 67/02; C08G 63/672; C08G 63/183

(52) U.S. Cl. 524/605; 528/301; 528/302; 525/444

(57) ABSTRACT

The present invention relates to a process for producing clingfilms by using biodegradable polyesters obtainable via polycondensation of:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.1 to 2% by weight, based on the polymer obtainable from components i to iii, of at least trifunctional crosslinking agent or at least difunctional chain extender.

The invention further relates to polymer mixtures which have particular suitability for producing clingfilms, and to clingfilms which comprise biodegradable polyesters.

The present invention relates to a process for producing clingfilms by using biodegradable polyesters obtainable via polycondensation of:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.1 to 2% by weight, based on the polymer obtainable from components i to iii, of at least trifunctional crosslinking agent or at least difunctional chain extender.

The invention further relates to a process for producing clingfilms by using polymer components a) and b):
a) from 5 to 95% by weight of a biodegradable polyester according to claim 1 and
b) from 95 to 5% by weight of an aliphatic-aromatic polyester obtainable via polycondensation of:
   i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 40 mol %, based on components i to ii, of a terephthalic acid derivative;
   iii) from 98 to 102 mol %, based on components i to ii, of a C₂-C₈-alkylenediol or C₂-C₆-oxyalkylenediol;
   iv) from 0 to 2% by weight, based on the polymer obtainable from components i to iii, of at least trifunctional crosslinking agent or difunctional chain extender.

The invention also relates to a process for producing clingfilms by using polymer components a), b), and c):
a) from 10 to 40% by weight of a biodegradable polyester according to claim 1 and
b) from 89 to 46% by weight of an aliphatic-aromatic polyester obtainable via polycondensation of:
   i) from 40 to 70 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 30 mol %, based on components i to ii, of a terephthalic acid derivative;
   iii) from 98 to 102 mol %, based on components i to ii, of a C₂-C₈-alkylenediol or C₂-C₆-oxyalkylenediol;
   iv) from 0 to 2% by weight, based on the polymer obtainable from components to iii, of at least trifunctional crosslinking agent or difunctional chain extender;
c) from 1 to 14% by weight of one or more polymers selected from the group consisting of: polylactic acid, polycaprolactone, polyhydroxyalkanoate, polyalkylene carbonate, chitosan, and gluten, and one or more polyesters based on aliphatic diols and on aliphatic dicarboxylic acids—
   and
   from 0 to 2% by weight of a compatibilizer.

WO-A 92/09654 describes linear aliphatic-aromatic polyesters which are biodegradable. WO-A 96/15173 describes crosslinked, biodegradable polyesters. The polyesters described have relatively high terephthalic acid content and are not always entirely satisfactory in terms of their film properties—in particular their elastic behavior, which is of great importance for clingfilm.

It was accordingly an object of the present invention to provide a process for producing clingfilms.

Surprisingly, the polyesters described in the introduction, which have very narrowly defined terephthalic acid content and narrowly defined crosslinking agent content have very good suitability for clingfilm.

Preference is given to biodegradable polyesters having the following constituents:

Component i is preferably adipic acid and/or sebacic acid.

Component iii), the diol, is preferably 1,4-butanediol.

Component iv), the crosslinking agent, is preferably glycerol.

The polyesters described are generally synthesized in a two-stage reaction cascade (see WO09/127,555 and WO09/127,556). The dicarboxylic acid derivatives are first reacted together with the diol (for example 1,4-butanediol) as in the synthesis examples, in the presence of a transesterification catalyst, to give a prepolyester. The intrinsic viscosity (IV) of said prepolyester is generally from 50 to 100 mL/g, preferably from 60 to 90 mL/g. Catalysts used are usually zinc catalysts, aluminum catalysts, and in particular titanium catalysts. An advantage of titanium catalysts, such as tetra(isopropyl) orthotitanate and in particular tetrabutyl orthotitanate (TBOT) in comparison with the tin catalysts, antimony catalysts, cobalt catalysts, and lead catalysts often used in the literature, an example being tin dioctanoate, is lower toxicity of any residual amounts of the catalyst, or downstream product from the catalyst, that remain within the product.

The polyesters of the invention are then optionally chain-extended by the processes described in WO 96/15173 and EP-A 488 617. By way of example, chain extenders vib), such as diisocyanates or epoxy-containing polymethacrylates, are used in a chain-extension reaction with the prepolyester to give a polyester with IV of from 60 to 450 mL/g, preferably from 80 to 250 mL/g.

A mixture of the dicarboxylic acids is generally first condensed in the presence of an excess of diol, together with the catalyst. The melt of the resultant prepolyester is usually then condensed at an internal temperature of from 200 to 250° C. within a period of from 3 to 6 hours at reduced pressure, with distillation to remove the diol liberated, until the desired viscosity has been achieved at an intrinsic viscosity (IV) of from 60 to 450 mL/g and preferably from 80 to 250 mL/g.

It is particular preferable that the polyesters of the invention are produced by the continuous process described in WO 09/127,556. The abovementioned intrinsic viscosity ranges serve merely as guidance for preferred process variants and do not restrict the subject matter of the present application.

Alongside the continuous process described above, a batch process can also be used to produce the polyesters of the invention. For this, the aliphatic and the aromatic dicarboxylic acid derivative, the diol, and a branching agent are mixed in any desired sequence of addition and condensed to give a prepolyester. The process can be adjusted to give a polyester with the desired intrinsic viscosity, optionally with the help of a chain extender.

The abovementioned processes can give by way of example polybutylene terephthalate succinates, polybutylene terephthalate azelates, polybutylene terephthalate brassylates, and in particular polybutylene terephthalate adipates and polybutylene terephthalate sebacates, having an acid number measured to DIN EN 12634 which is smaller than 1.0 mg KOH/g and having an intrinsic viscosity which is greater than 130 mL/g, and also having an MVR to ISO 1133 which is smaller than 6 cm³/10 min (190° C., 2.16 kg weight). Said products are of particular interest for film applications.

Sebacic acid, azelaic acid, and brassylic acid (i) are obtainable from renewable raw materials, in particular from vegetable oils, e.g. castor oil.

The amount of terephthalic acid ii used is from 20 to 35 mol %, based on the acid components i and ii.

Terephthalic acid and the aliphatic dicarboxylic acid can be used either in the form of free acid or in the form of ester-forming derivatives. Particular ester-forming derivatives that may be mentioned are the di-C₁-C₆-alkyl esters, such as dimethyl, diethyl, di-n-propyl, diisopropyl, di-n-butyl, diisobutyl, di-tert-butyl, di-n-pentyl, diisopentyl, or di-n-hexyl esters. It is equally possible to use anhydrides of the dicarboxylic acids.

The dicarboxylic acids or ester-forming derivatives thereof can be used individually or in the form of a mixture here.

1,4-Butanediol is equally accessible from renewable raw materials. WO 09/024,294 discloses a biotechnological process for producing 1,4-butanediol by starting from various carbohydrates and using Pasteurellaceae microorganisms.

At the start of the polymerization reaction, the ratio of the diol (component iii) to the acids (components i and ii) is generally set at from 1.0 to 2.5:1 and preferably from 1.3 to 2.2:1 (diol: diacids). Excess amounts of diol are drawn off during the polymerization reaction, so as to obtain an approximately equimolar ratio at the end of the polymerization reaction. Approximately equimolar means a diol/diacid ratio of from 0.98 to 1.02:1.

The polyesters mentioned can comprise hydroxy and/or carboxy end groups in any desired ratio. The semiaromatic polyesters mentioned can also be end-group-modified. By way of example, therefore, OH end groups can be acid-modified by reaction with phthalic acid, phthalic anhydride, trimellitic acid, trimellitic anhydride, pyromellitic acid, or pyromellitic anhydride. Preference is given to polyesters having acid numbers smaller than 1.5 mg KOH/g.

Use is generally made of a crosslinking agent iva and optionally also of a chain extender ivb selected from the group consisting of: a polyfunctional isocyanate, isocyanurate, oxazoline, epoxide, carboxylic anhydride, an at least trifunctional alcohol, or an at least trifunctional carboxylic acid. Chain extenders ivb that can be used are polyfunctional and in particular difunctional isocyanates, isocyanurates, oxazolines, carboxylic anhydride, or epoxides. The concentration generally used of the crosslinking agents iva) is from 0.1 to 2% by weight, preferably from 0.2 to 1.5% by weight, and with particular preference from 0.3 to 1% by weight, based on the polymer obtainable from components i to iii. The concentration generally used of the chain extenders ivb) is from 0.01 to 2% by weight, preferably from 0.1 to 1% by weight, and with particular preference from 0.35 to 2% by weight, based on the total weight of components i to iii.

Chain extenders, and also alcohols or carboxylic acid derivatives having at least three functional groups, can also be regarded as crosslinking agents. Particularly preferred components have from 3 to 6 functional groups. By way of example, mention may be made of: tartaric acid, citric acid, malic acid; trimethylolpropane, trimethylolethane; pentaerythritol; polyethertriols and glycerol, trimesic acid, trimellitic acid, trimellitic anhydride, pyromellitic acid, and pyromellitic dianhydride. Preference is given to polyols such as trimethylolpropane, pentaerythritol, and in particular glycerol. By means of components iv it is possible to construct biodegradable polyesters that are pseudoplastic. The rheological behavior of the melts improves; the biodegradable polyesters are easier to process, for example easier to draw to give films by the melt-solidification process. The compounds iv reduce viscosity under shear, i.e. viscosity is reduced under load.

It is generally useful to add the crosslinking (at least trifunctional) compounds at a relatively early juncture within the polymerization reaction.

Suitable bifunctional chain extenders are aromatic diisocyanates and in particular aliphatic diisocyanates, especially linear or branched alkylene diisocyanates, or cycloalkylene diisocyanates having from 2 to 20 carbon atoms, preferably from 3 to 12 carbon atoms, e.g. hexamethylene 1,6-diisocyanate, isophorone diisocyanate, or methylenebis(4-isocyanatocyclohexane). Particularly preferred aliphatic diisocyanates are isophorone diisocyanate and in particular hexamethylene 1,6-diisocyanate.

The number-average molar mass (Mn) of the polyesters of the invention is generally in the range from 5000 to 100 000 g/mol, in particular in the range from 10 000 to 60 000 g/mol, preferably in the range from 15 000 to 38 000 g/mol, their weight-average molecular mass (Mw) being from 30 000 to 300 000 g/mol, preferably from 60 000 to 200 000 g/mol, and their Mw/Mn ratio being from 1 to 15, preferably from 2 to 8. Intrinsic viscosity is from 30 to 450 mL/g, preferably from 50 to 400 mL/g, and with particular preference from 80 to 250 mL/g (measured in o-dichlorobenzene/phenol (ratio by weight 50/50)). The melting point is in the range from 85 to 150° C., preferably in the range from 95 to 140° C.

In one preferred embodiment, from 1 to 80% by weight, based on the total weight of components i to iv, of an organic filler is added, selected from the group consisting of: native or plastified starch, natural fibers, wood flour, comminuted cork, ground bark, nut shells, ground press cake (vegetable-oil refining), dried production residues from the fermentation or distillation of drinks, such as beer or fermented nonalcoholic drinks (e.g. Bionade), wine, or sake, and/or of an inorganic filler selected from the group consisting of: chalk, graphite, gypsum, conductive carbon black, iron oxide, calcium chloride, dolomite, kaolin, silicon dioxide (quartz), sodium carbonate, titanium dioxide, silicate, wollastonite, mica, montmorillonites, talc, glass fibers, and mineral fibers.

Starch and amylose can be native, i.e. not thermoplastified or thermoplastified with plasticizers, such as glycerol or sorbitol (EP-A 539 541, EP-A 575 349, EP 652 910).

Examples of natural fibers are cellulose fibers, hemp fibers, sisal, kenaf, jute, flax, abacca, coconut fiber, or else regenerated cellulose fibers (rayon), e.g. Cordenka fibers.

Preferred fibrous fillers that may be mentioned are glass fibers, carbon fibers, aramid fibers, potassium titanate fibers, and natural fibers, particular preference being given to glass fibers in the form of E glass. These can be used in the form of rovings or in particular in the form of chopped glass in the forms commercially available. The diameter of said fibers is generally from 3 to 30 μm, preferably from 6 to 20 μm, and particularly preferably from 8 to 15 μm. The length of the fibers within the compounding material is generally from 20 μm to 1000 μm, preferably from 180 to 500 μm, and particularly preferably form 200 to 400 μm.

The fibrous fillers can, for example, have been surface-pretreated with a silane compound in order to improve compatibility with the thermoplastic.

The biodegradable polyesters and, respectively, polyester mixtures can comprise other ingredients that are known to the person skilled in the art but that are not essential to the invention. Examples are the additives usually used in plastics technology, e.g. stabilizers; nucleating agents; neutralizing agents; lubricants and release agents, such as stearates (in particular calcium stearate); plasticizers, such as citric esters (in particular tributyl acetylcitrate), glycerol esters, such as triacetylglycerol, or ethylene glycol derivatives, surfactants, such as polysorbates, palmitates, or laureates; waxes, such as beeswax or beeswax esters; antistatic agents, UV absorbers; UV stabilizers; antifogging agents, or dyes. The concentrations used of the additives are from 0 to 5% by weight, in particular from 0.1 to 2% by weight, based on the polyesters of the invention. The polyesters of the invention can comprise from 0.1 to 10% by weight of plasticizers.

The biodegradable polyesters according to claim 1 are often tacky. If the polyesters are intended for use alone rather than as part of a blend, it is useful to add additives, particular examples being lubricants and release agents, so that processing of the polyesters to give films is problem-free.

Particular lubricants or mold-release agents (component e) that have proven successful are hydrocarbons, fatty alcohols, higher carboxylic acids, metal salts of higher carboxylic acids, e.g. calcium stearate or zinc stearate, fatty acid amides, such as erucamide, and waxes, e.g. paraffin waxes, beeswax, or montan waxes. Preferred lubricants are erucamide and/or waxes, and particularly preferably combinations of these lubricants. Preferred waxes are beeswax and ester waxes, in particular glycerol monostearate, or dimethylsiloxane, or polydimethylsiloxane, e.g. Belsil® DM from Wacker.

The amount added of component e is generally from 0.05 to 5.0% by weight and preferably from 0.1 to 2.0% by weight, based on the biodegradable polyester.

One preferred formulation of the biodegradable polyester comprises:
a) from 99.9 to 98% by weight of an aliphatic-aromatic polyester obtainable via polycondensation of:
   i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 35 to 20 mol %, based on components i to ii, of a terephthalic acid derivative;
   iv) from 98 to 102 mol %, based on components i to ii, of a C₂-C₈-alkylenediol or C₂-C₆-oxyalkylenediol;
   iv) from 0.1 to 2% by weight, based on the polymer obtainable from components i to iii, of at least trifunctional crosslinking agent or difunctional chain extender, and
b) from 0.1 to 2% by weight of a lubricant or release agent.

Preference is further given to clingfilms comprising the abovementioned formulations.

The abovementioned formulations and biodegradable polyester mixtures of the invention can be produced from the individual components by known processes (EP 792 309 and U.S. Pat. No. 5,883,199). By way of example, all of the components of the mixture can be mixed and reacted in one step in mixing apparatuses known to the person skilled in the art, examples being kneaders or extruders, at elevated temperatures, for example from 120° C. to 250° C.

Typical polyester mixtures for clingfilm production comprise:
a) from 5 to 95% by weight, preferably from 10 to 40% by weight, and particularly preferably from 25 to 35% by weight, of a biodegradable polyester according to claim 1 and
b) from 95 to 50% by weight, preferably from 90 to 60% by weight, and particularly preferably from 75 to 65% by weight, of an aliphatic-aromatic polyester obtainable via polycondensation of:
   i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 40 mol %, based on components i to ii, of a terephthalic acid derivative;
   iii) from 98 to 102 mol %, based on components i to ii, of a C₂-C₈-alkylenediol or C₂-C₆-oxyalkylenediol;
   iv) from 0 to 2% by weight, based on the polymer obtainable from components i to iii, of at least trifunctional crosslinking agent or difunctional chain extender.

The following polymer mixtures are moreover suitable for producing clingfilms:
a) from 10 to 40% by weight, preferably from 20 to 30% by weight, of a biodegradable polyester according to claim 1, and
b) from 89 to 46% by weight of an aliphatic-aromatic polyester obtainable via polycondensation of:
   i) from 40 to 70 mol %, based on components i to ii, of one or more dicarboxylic acid derivatives or dicarboxylic acids selected from the group consisting of: succinic acid, adipic acid, sebacic acid, azelaic acid, and brassylic acid;
   ii) from 60 to 30 mol %, based on components i to ii, of a terephthalic acid derivative;
   v) from 98 to 102 mol %, based on components i to ii, of a C₂-C₈-alkylenediol or C₂-C₆-oxyalkylenediol;
   vi) from 0 to 2% by weight, based on the polymer obtainable from components to iii, of at least trifunctional crosslinking agent or difunctional chain extender;
c) from 1 to 14% by weight, preferably from 1 to 10% by weight, of one or more polymers selected from the group consisting of: polylactic acid, polycaprolactone, polyhydroxyalkanoate, polyalkylene carbonate, chitosan, and gluten, and one or more polyesters based on aliphatic diols and on aliphatic dicarboxylic acids—
   and
   from 0 to 2% by weight of a compatibilizer.

The excellent recovery behavior of the abovementioned polyester mixtures comprising components a) and b) and, respectively, a), b), and c) makes them suitable as clingfilms.

It is preferable that the polymer mixtures in turn comprise from 0.05 to 2% by weight of a compatibilizer. Preferred compatibilizers are carboxylic anhydrides, such as maleic anhydride, and in particular the styrene-, acrylic-ester-, and/or methacrylic-ester-based copolymers described above that comprise epoxy groups. The units bearing epoxy groups are preferably glycidyl (meth)acrylates. Copolymers of the above-mentioned type containing epoxy groups are marketed by way of example by BASF Resins B.V. with trademark Joncryl® ADR. By way of example, Joncryl® ADR 4368 is particularly suitable as compatibilizer.

Polylactic acid is suitable by way of example as biodegradable polyester (component b). It is preferable to use polylactic acid with the following property profile:
melt volume rate (MVR for 190° C. and 2.16 kg to ISO 1133) or from 0.5 to 30 ml/10 minutes, preferably from 2 to 18 ml/10 minutes
melting point below 240° C.
glass transition temperature (Tg) above 55° C.
water content smaller than 1000 ppm
residual monomer content (lactide) smaller than 0.3%
molecular weight greater than 80 000 daltons.

Examples of preferred polylactic acids are NatureWorks® 3001, 3051, 3251, 4020, 4032, or 4042D (polylactic acid from NatureWorks or NL-Naarden and USA Blair/Nebraska).

Polyhydroxyalkanoates are primarily poly-4-hydroxybutyrates and poly-3-hydroxybutyrates, and the term also comprises copolyesters of the above-mentioned hydroxybutyrates with 3-hydroxyvalerates or 3-hydroxyhexanoate. Poly-3-hydroxy-butyrate-co-4-hydroxybutyrates are in particular known from Metabolix. They are marketed with trademark Mirel®. Poly-3-hydroxybutyrate-co-3-hydroxyhexanoates are known from P&G or Kaneka. Poly-3-hydroxybutyrates are marketed by way of example by PHB Industrial with trademark Biocycle® and by Tianan as Enmat®.

The molecular weight Mw of the polyhydroxyalkanoates is generally from 100 000 to 1 000 000 and preferably from 300 000 to 600 000.

Polycaprolactone is marketed as Placcel® by Daicel.

Polyalkylene carbonates are in particular polyethylene carbonate and polypropylene carbonate.

The expression semiaromatic (aliphatic-aromatic) polyesters based on aliphatic diols and on aliphatic/aromatic dicarboxylic acids (component c) also covers polyester derivatives such as polyetheresters, polyesteramides, or polyetheresteramides. Among the suitable semiaromatic polyesters are linear non-chain-extended polyesters (WO 92/09654). Particularly suitable constituents in a mixture are aliphatic/aromatic polyesters made of butanediol, terephthalic acid, and of aliphatic C₆-C₁₈ dicarboxylic acids, such as adipic acid, sorbic acid, azelaic acid, sebacic acid, and brassylic acid (for example as described in WO 2006/097353 to 56). Preference is given to chain-extended and/or branched semiaromatic polyesters. The latter are known from the following specifications mentioned in the introduction: WO 96/15173 to 15176, 21689 to 21692, 25446, 25448, or WO 98/12242, and these are expressly incorporated herein by way of reference. It is equally possible to use a mixture of various semiaromatic polyesters. Particular semiaromatic polyesters are products such as Ecoflex® (BASF SE), Eastar® Bio, and Origo-Bi® (Novamont). In comparison with the biodegradable polyesters of claim 1, they have relatively high terephthalic acid content (aromatic dicarboxylic acid).

For the purposes of the present invention, a substance or a substance mixture complies with the “biodegradable” feature if said substance or the substance mixture has a percentage degree of biodegradation of at least 90% to DIN EN 13432.

Biodegradation generally leads to decomposition of the polyesters or polyester mixtures in an appropriate and demonstrable period of time. The degradation can take place by an enzymatic, hydrolytic, or oxidative route, and/or via exposure to electromagnetic radiation, such as UV radiation, and can mostly be brought about predominantly via exposure to microorganisms, such as bacteria, yeasts, fungi, and algae. Biodegradability can be quantified by way of example by mixing polyester with compost and storing it for a particular period. By way of example, in DIN EN 13432, CO₂-free air is passed through ripened compost during the composting process, and the compost is subjected to a defined temperature profile. Biodegradability here is defined as a percentage degree of biodegradation, by taking the ratio of the net amount of CO₂ released from the specimen (after subtraction of the amount of CO₂ released by the compost without specimen) to the maximum amount of CO₂ that can be released from the specimen (calculated from the carbon content of the specimen). Biodegradable polyesters or biodegradable polyester mixtures generally exhibit marked signs of degradation after just a few days of composting, examples being fungal growth, cracking, and perforation.

Other methods of determining biodegradability are described by way of example in ASTM D 5338 and ASTM D 6400-4.

The clingfilms (freshness-retention films) are generally produced within the thickness range from 10 to 25 μm. The usual production process is blown-film extrusion in one layer in the form of monofilm. The chill-roll extrusion process has also become established as a process for coextruded freshness-retention films.

Most of the clingfilms available hitherto within the market are mainly composed of PVC, plasticizer (e.g. from 20 to 30% of dioctyl phthalate) and antifogging additives, which reduce the amount of condensation on the film during temperature changes.

Clingfilms based on LDPE have also become established, but require a cling additive (polyisobutylene). Clingfilms made of PE also comprise antifogging additives.

One specific clingfilm variant comprises a styrene/butadiene copolymer (Styroflex) which has excellent capability for recovery after deformation. These films are produced with 3 layers. The external layers comprise an ethylene-vinyl acetate equipped with antifogging additives. The middle layer comprises the styrene/butadiene copolymer that provides the strength, the extensibility, and the capability for recovery.

Clingfilms are used for packaging fruit and vegetables, and also fresh meat, bones, and fish. The requirements profile applicable to these is as follows:
1. extrudability on specific blown-film plants:
   a. bubble stability at 10 μm
   b. MFR (190° C., 2.16 kg) in the range from 0.3 to 4 g/10 min.
2. Transparency
3. Capability for recovery after deformation (hysteresis)
4. Strength to prevent slippage of the contents of the package
5. Puncture resistance
6. Ease of cutting perpendicularly to the direction of extrusion
7. Antifogging effect between room temperature and 0° C. in cold storage
8. Weldability on the packing line or for manual packing

### Traditional PVC Film Serves as Comparison:

Films made of biodegradability polyester according to claim 1 have good film properties and can give very good results in drawing down to 10 μm. The level of mechanical properties is high, examples being strength values longitudinally and perpendicularly with respect to the direction of extrusion, and puncture resistance.

Blown films produced from said polyesters exhibit highly elastomeric behavior. The pre-breaking strengths achieved by the films are higher than those for PVC. It is therefore useful to modify the stiffness-toughness ratio by using branching agents and to reduce the terephthalic acid content for clingfilms.

Clingfilms produced from said polyesters can also be equipped with antifogging additives. The transparency of these clingfilms is sufficient for most applications. However, they are not quite as transparent as PVC and in this respect they differ from traditional PVC.

The improved hysteresis (capability for recovery after deformation) of clingfilms of the invention is particularly impressive.

The clingfilms of the invention are also easier to cut, without tearing longitudinally with respect to the direction of extrusion, since the marked anisotropy of the film is reduced with lower terephthalic acid content and a higher degree of branching.

The level of weldability of the clingfilms of the invention is similar to that of PVC or PE.

### Measurements of Performance Characteristics:

The molecular weights Mn and Mw of the semiaromatic polyesters were determined to DIN 55672-1 with eluent hexafluoroisopropanol (HFIP)+0.05% by weight of potassium trifluoroacetate; narrowly distributed polymethyl methacrylate standards were used for calibration. Intrinsic viscosities were determined to DIN 53728 part 3, Jan. 3, 1985, capillary viscosimetry. An M-II micro-Ubbelohde viscometer was used. The solvent used was the following mixture: phenol/o-dichlorobenzene in a ratio by weight of 50/50. The hysteresis test was carried out at 23° C. to DIN 53835 on films of thickness 60 μm. The film was first stressed at a rate of 120 mm/min. Once 50% tensile strain had been reached, the load was removed, with no waiting time. A waiting time of 5 minutes then followed. The second cycle then followed, using 100% tensile strain at the peak.

The degradation rates of the biodegradable polyester mixtures and of the mixtures produced for comparison were determined as follows:

The biodegradable polyester mixtures and the mixtures produced for comparison were pressed at a 190° C., in each case to produce films of thickness 30 μm. Each of these films was cut into square pieces with edge lengths of 2×5 cm. The weight of each of these pieces of film was determined and defined as “100% by weight”. The pieces of film were heated to 58° C. in an oven for a period of 4 weeks in a plastics jar filled with moistened compost. At weekly intervals the residual weight of each piece of film was measured and converted to % by weight (based on the weight defined as “100% by weight” determined at the start of the experiment.

### Starting Materials

### Polyester A1

A polybutylene terephthalate adipate produced as follows: 110.1 g of dimethyl terephthalate (27 mol %), 224 g of adipic acid (73 mol %), 246 g of 1,4-butanediol (130 mol %), and 0.34 ml of glycerol (0.1% by weight, based on the polymer) were mixed together with 0.37 ml of tetrabutyl orthotitanate (TBOT), the molar ratio of alcohol components to acid component being 1.30. The reaction mixture was heated to a temperature of 210° C. and kept at said temperature for 2 h. The temperature was then increased to 240° C. and the system was subjected to stepwise evacuation. The excess of dihydroxy compound was removed by distillation under a vacuum below 1 mbar over a period of 3 h. The melting point of the resultant polyester A1 was 60° C. and its IV was 156 ml/g.

### Polyester A2

A polybutylene terephthalate adipate produced as follows: 583.3 g of dimethyl terephthalate (27 mol %), 1280.2 g of adipic acid (73 mol %), 1405.9 g of 1,4-butanediol (130 mol %), and 37 ml of glycerol (1.5% by weight, based on the polymer) were mixed together with 1 g of tetrabutyl orthotitanate (TBOT), the molar ratio of alcohol components to acid component being 1.30. The reaction mixture was heated to a temperature of 210° C. and kept at said temperature for 2 h. The temperature was then increased to 240° C. and the system was subjected to stepwise evacuation. The excess of dihydroxy compound was removed by distillation under a vacuum below 1 mbar over a period of 3 h. The melting point of the resultant polyester A2 was 60° C. and its IV was 146 ml/g.

### Polyester A3

A polybutylene terephthalate adipate produced as follows: 697.7 g of terephthalic acid (35 mol %), 1139.9 g of adipic acid (65 mol %), 1405.9 g of 1,4-butanediol (130 mol %), and 37.3 ml of glycerol (1.5% by weight, based on the polymer) were mixed together with 2.12 ml of tetrabutyl orthotitanate (TBOT), the molar ratio of alcohol components to acid component being 1.30. The reaction mixture was heated to a temperature of 210° C. and kept at said temperature for 2 h. The temperature was then increased to 240° C. and the system was subjected to stepwise evacuation. The excess of dihydroxy compound was removed by distillation under a vacuum below 1 mbar over a period of 2 h. The melting point of the resultant polyester A3 was 80° C. (broad) and its IV was 191 ml/g.

### Polyester A4

A polybutylene terephthalate adipate produced as follows: 726.8 g of terephthalic acid (35 mol %), 1187.4 g of adipic acid (65 mol %), 1464.5 g of 1,4-butanediol (130 mol %), and 372.06 ml of glycerol (0.1% by weight, based on the polymer) were mixed together with 2.21 ml of tetrabutyl orthotitanate (TBOT), the molar ratio of alcohol components to acid component being 1.30. The reaction mixture was heated to a temperature of 210° C. and kept at said temperature for 2 h. The temperature was then increased to 240° C. and the system was subjected to stepwise evacuation. The excess of dihydroxy compound was removed by distillation under a vacuum below 1 mbar over a period of 3 h. The melting point of the resultant polyester A4 was 80° C. and its IV was 157 ml/g.

### Polyester B1

A polybutylene terephthalate adipate produced as follows: 87.3 kg of dimethyl terephthalate (44 mol %), 80.3 kg of adipic acid (56 mol %), 117 kg of 1,4-butanediol, and 0.2 kg of glycerol (0.1% by weight, based on the polymer) were mixed together with 0.028 kg of tetrabutyl orthotitanate (TBOT), the molar ratio of alcohol components to acid component being 1.30. The reaction mixture was heated to a temperature of 180° C. and reacted for 6 h at this temperature. The temperature was then increased to 240° C. and excess dihydroxy compound was removed by distillation in vacuo over a period of 3 h. 0.9 kg of hexamethylene diisocyanate were then slowly metered in within a period of 1 h at 240° C. The melting point of the resultant polyester B1 was 119° C., its molar mass (Mₙ) was 23 000 g/mol, and its molar mass (M_{w}) was 130 000 g/mol.

### Polyester C1

NatureWorks 4042D® polylactic acid

### Compatibilizer D1

Joncryl ADR 4368CS

### EXAMPLES

Polyesters A1, A3, and A4, and comparative example B1, were processed in the heated press to give pressed films FA1; FA3, FA4, and comparative film FB1, and subjected to a hysteresis test.

### Production of Pressed Films

2.5 g of polyester was distributed within the frame (60 μm, 20×20 cm). The frames were placed in the press. The polymer was then heated to a temperature of 160° C. and 10 min at said temperature. The plates of the press were then brought into contact with the polymer films and a pressure up to 200 bar was applied stepwise. After 2 min, the plates of the press were cooled to RT and the pressure was removed from the plates.

### Hysteresis Test

The hysteresis test was carried out at 23° C. to DIN 53835 on films of thickness 60 μm. First, the films were cut to dimensions of 4 mm*25 mm. These pieces of film were then stressed at a rate of 120 mm/min. Once 50% tensile strain had been reached, the load was removed, with no waiting time (first measurement of recovery capability). A waiting time of 6 minutes then followed. The second cycle then followed, using 100% tensile strain at the peak.

| | | Recovery after 50% | Recovery after 100% |
|---|---|---|---|
| | Thickness | tensile strain (1st | tensile strain (2nd |
| Specimen | (μm) | measurement) | measurement) |
| FA1 | 60 | 83% | 63% |
| FA3 | 65 | 74% | 62% |
| FA4 | 65 | 68% | 56% |
| FB1 | 60 | 44% | 34% |

The measurements show that the films composed of a polyester having low terephthalic acid content, for example FA1, exhibit higher recovery capability than the comparative film FB1. There was a further increase in the recovery capability of films having high content of crosslinking agent (FA3 in comparison with FA4).

1.-12. (canceled)

13. A process for producing clingfilms which comprises utilizing a biodegradable polyester obtainable via polycondensation of:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.1 to 2% by weight, based on the polymer obtainable from components i to iii, of at least trifunctional crosslinking agent or difunctional chain extender.

14. The process according to claim 13, wherein the crosslinking agent (component iv) in the biodegradable polyester is glycerol.

15. The process according to claim 13, wherein the dicarboxylic acid (component i) used comprises adipic acid or sebacic acid or a mixture thereof.

16. The process according to claim 14, wherein the dicarboxylic acid (component i) used comprises adipic acid or sebacic acid or a mixture thereof.

17. A process for producing clingfilms which comprises utilizing polymer components a) and b):
a) from 5 to 95% by weight of the biodegradable polyester according to claim 13 and
b) from 95 to 5% by weight of an aliphatic-aromatic polyester obtainable via polycondensation of:
i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 60 to 40 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0 to 2% by weight, based on the polymer obtainable from components i to iii, of at least trifunctional crosslinking agent or difunctional chain extender.

18. A process for producing clingfilms which comprises utilizing polymer components a), b), and c):
a) from 10 to 40% by weight of the biodegradable polyester according to claim 13 and
b) from 89 to 46% by weight of an aliphatic-aromatic polyester obtainable via polycondensation of:
i) from 40 to 70 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 60 to 30 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0 to 2% by weight, based on the polymer obtainable from components i to iii, of at least trifunctional crosslinking agent or difunctional chain extender;
c) from 1 to 14% by weight of one or more polymers selected from the group consisting of: polylactic acid, polycaprolactone, polyhydroxyalkanoate, polyalkylene carbonate, chitosan, and gluten, and one or more polyesters based on aliphatic diols and on aliphatic dicarboxylic acids—
and
from 0 to 2% by weight of a compatibilizer.

19. The process according to claim 17, wherein production of the films uses mixtures comprising polymer components a) and b) or polymer components a), b), and c).

20. The process according to claim 19, wherein the mixtures comprise from 0.05 to 2% by weight of an epoxy-comprising poly(meth)acrylate as compatilizer.

21. The process according to claim 17, wherein multilayer films are produced via coextrusion, where at least the middle and/or inner layer of the film comprises said biodegradable polyester.

22. The process according to claim 16, wherein component c) is polylactic acid.

23. The polymer mixture comprising:
a) from 5 to 95% by weight of a biodegradable polyester obtainable via polycondensation of:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.1 to 2% by weight, based on the polymer obtainable from components i to iii, of at least trifunctional crosslinking agent or difunctional chain extender;
b) from 95 to 5% by weight of an aliphatic-aromatic polyester obtainable via polycondensation of:
i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
from 60 to 40 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0 to 2% by weight, based on the polymer obtainable from components i to iii, of at least trifunctional crosslinking agent or difunctional chain extender.

24. A polymer mixture comprising:
a) from 10 to 40% by weight of a biodegradable polyester comprising:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.1 to 2% by weight, based on the polymer obtainable from components i to iii, of at least trifunctional crosslinking agent or difunctional chain extender;
b) from 89 to 46% by weight of an aliphatic-aromatic polyester obtainable via polycondensation of:
i) from 40 to 60 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 60 to 40 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0 to 2% by weight, based on the polymer obtainable from components i to iii, of at least trifunctional crosslinking agent or difunctional chain extender;
c) from 1 to 14% by weight of one or more polymers selected from the group consisting of: polylactic acid, polycaprolactone, polyhydroxyalkanoate, polyalkylene carbonate, chitosan, and gluten, and one or more polyesters based on aliphatic diols and on aliphatic dicarboxylic acids—
and
from 0 to 2% by weight of a compatibilizer.

25. A clingfilm comprising:
a) from 99.9 to 98% by weight of a biodegradable polyester comprising:
i) from 65 to 80 mol %, based on components i to ii, of one or more dicarboxylic acid derivatives or dicarboxylic acids selected from the group consisting of: succinic acid, adipic acid, sebacic acid, azelaic acid, and brassylic acid;
ii) from 35 to 20 mol %, based on components i to ii, of a terephthalic acid derivative;
iii) from 98 to 102 mol %, based on components i to ii, of a C₂-C₈-alkylenediol or C₂-C₆-oxyalkylenediol;
iv) from 0.1 to 2% by weight, based on the polymer obtainable from components i to iii, of at least trifunctional crosslinking agent or difunctional chain extender, and
b) from 0.1 to 2% by weight of a lubricant or release agent.
